(19) United States
(12) Patent Application Publication
(10) Pub. No.: US 2006/0144705 A1
(43) Pub. Date: Jul. 6, 2006

(54) Silicon seal for microprobes

(76) Inventor: Stefan Martin Hanstein, Lollar (DE)

Correspondence Address: CLARK & BRODY, 1090 VERMONT AVENUE, NW, SUITE 250, WASHINGTON, DC, 20005, US

(21) Appl. No.: 10/525,338

(22) PCT Filed: Aug. 19, 2003
(86) PCT No.: PCT/DE03/02777

§ 371 Date: Feb. 22, 2005

(30) Foreign Application Priority Data
Aug. 22, 2002 (DE) 102 39 264.1

(51) Int. Cl. G01N 27/26

(52) U.S. Cl. 204/415; 204/431

(57) ABSTRACT

The invention relates to silicone gaskets for measuring gas concentrations, procedures to produce these gaskets and procedures to produce microsensor which utilize these gaskets. The gaskets are characterized by a high permeability for the analyte, are electrically insulating and can be realized within microsensors. The microsensors based on the current invention are particularly appropriate for phytophysiological measurements and can be utilized, for instance, for high resolution measurements of gases in the single stomata of plant leaves.

The qualitative and quantitative detection of gases as well as of gases and ions dissolved in liquids play a decisive role in science and technology. Currently existing probes and sensors allow for the detection of gases, ions or ions derived from gaseous substances, e.g. in combustors, during waste gas control and in numerous biological systems. In doing so, several measuring methods are applied to determine substances. The application of a specific measuring method depends on the character and the estimated concentration of the substance to be determined and of the location resp. the point of measurement (macro or micro range).

Such physical and/or chemical properties of the analyte are suitable for detection which allow for definite conclusions as to the analyte's nature and correlate proportionally to their concentration. The commonly used measuring methods comprise potentiometric and amperometric procedures as well as measurements of conductivity, temperature, pressure resp. partial pressure, resonance frequency and magnetic susceptibility. Depending on the measurement setup and the analyte's nature, the change in the analyte's properties (primary substance) may be detected directly, or the analyte is transferred into a secondary substance which is measured subsequently. In the latter case, a defined mathematical ratio of the primary to the secondary substance is a prerequisite.

In many cases, measuring equipments containing semipermeable membranes are employed to determine analytes also in substance mixtures. These semipermeable membranes separate the actual measuring area from the mixture to be analyzed. In an ideal case, this membrane can be permeated by only a single or a few substances to be analyzed. This membrane may consist of e.g. glass, synthetics/polymers or metallic compounds. For a long time, silicone membranes have been applied in sensors to measure carbon dioxide and oxygen. The high electric resistance of silicones ensures that the electric potential of the measuring solution does not influence the sensor circuit when the sensor is used in conductive media.

### DESCRIPTION AND TECHNICAL STATE OF THE ART

At present, several electrodes and sensors are known which measure gaseous substances or gases and ions dissolved in liquids. Several chemical and physical parameters are thereby used to identify the analytes to be determined, if necessary even in mixtures of substances. Many measuring methods use different electrodes consisting of noble metals and the salts thereof. The salt may be dissolved or solid, depending on the construction design of the electrode. Detection of the analyte may be carried out e.g. by amperometric or potentiometric measurement. Very often, the sensor detection limit, a too low selectivity for a particular analyte in a mixture as well as the time need for the reception of a detection signal are disadvantageous for the measurement of low or rapidly changing analyte concentrations.

A semipermeable membrane between the measurement medium and the detection system is characteristic for all measurement setups. The semipermeable membrane is only permeable for the analyte or the mixture of substances to be analyzed, thus increasing the selectivity of the measurement.

DE 19921532 A1, DE 96402705 T2, DE 69031901 T2, DE 19914628 A1 and WO 97/46853 describe sensors which measure gases amperometrically, potentiometrically or via partial pressure, temperature, electrical or thermal conductivity, and/or adsorption, as the case may be. According to DE 35 41 341 C2, oxygen can be determined by measuring the O₂-dependent change of magnetic susceptibility. DE 196 02 861 C2 describes an oxygen sensor consisting of a dialysis membrane, a silver-silver chloride anode and a cathode of silver or platinum. The membrane is made of a gel which contains a salt as well as an enzyme. In contrast to the invention at hand, it does not deal with an electrically insulating polymer.

There are numerous publications concerning the measurement of ions in biological samples: DE 40 13 665 C2 describes quartz crystal sensors whose resonance frequency depends on the analyte concentration within the sample solution, whereby perturbations of the metabolism of biological samples can not be excluded. DE 694 15 644 T2 describes a chloride-sensitive electrode with a silicone membrane to measure chloride ions. A microsensor containing bacteria for the determination of nitrate is described in WO 99/45376. DE 38 13 709 A1 and DE 695 14 427 T2 describe electrodes containing a polymer layer with active enzymes to measure substances in bodily fluids. DE 100 18 750 A1 characterizes an electrode that consists of an intrinsically conductive, polymeric contact layer and an ion selective glass membrane. All aforementioned electrodes and sensors, however, are not suitable for the measurement of the smallest of concentrations or volumes within biological samples. The measurement principle of many sensors is based on a stoichiometric reaction of a primary analyte yielding a secondary analyte. In many cases, an electric circuit is part of the measurement setup. Said electric circuit responds to the concentration and the activity of the secondary analyte resp. and delivers a measurement signal depending on said analyte's concentration. Due to the required sensitivity of measurement, potentiometric sensors have to reveal measurement signals in the range of 50 μV. Thus the electric circuit of these sensors has to be electrically insulated from the sample. Otherwise the electric potential would falsify the result of measurement. Furthermore, it is advantageous to prevent dilution of the secondary analyte—caused by its diffusion out of the sensor—by suitable membranes. Chemical properties of silicone can combine both electrically insulating and (gas) permeable characteristics.

All the aforementioned inventions feature membranes with permeable, but not electrically insulating properties. In contrast, DE 695 19 698 T2 describes thermosetting silicone composites for separation coatings which, however, are not gas permeable. Furthermore, DE 41 18 667 A1 describes a reference junction for potentiometric series of measurements manufactured from gas- and fluid-proof silicone adhesives and pottants. Though the gaskets of both of the inventions last-mentioned are electrically insulating, they are not analyte permeable.

Semipermeable membranes described in the aforementioned inventions cannot be utilized for the permanent electrical insulation of an electrolyte solution in microcapillaries. None of the above mentioned inventions combines electrically insulating and semipermeable characteristics in one microsensor. However, such a combination is mandatory for potentiometric microsensors to be able to measure the smallest of analyte concentrations in the micro range without disturbing or changing the system surrounding the sensor.

A sufficient degree of cross-linking of silicone ingredients is a prerequisite in achieving mechanically stable silicone gaskets. Silicones whose cross-linking proceeds at room temperature in the presence of air humidity are commonly used in electronics (e.g. Dow Corning® RTV 3140). Their fluidity is sufficient to penetrate dry microcapillaries. Yet the high interface tension between the silicone phase and the aqueous phase makes it difficult to build up an adequate interface because it is energetically unfavorable. With the help of even narrower filling capillaries, the aqueous phase has to be injected close to the gasket from inside. Alone the ejection of the water from the filling capillaries requires a high injection pressure. Energy demand increases further due to the high interface tension to be established. Very often, air remains between the hydrophobic and aqueous phase as this is the energetically more favorable state.

Another technical approach is to build up the phase interface already at the opening of the microcapillary by immersing a microcapillary already filled with water in an appropriate silicone oil and generating a negative pressure within the capillary. As for the present state of the art, no silicone formulations are known which cross-link at room temperature whose fluidity remains large enough for a sufficient period of time to allow them to be aspirated into very fine water-filled microcapillaries. A gas microsensor based on a commercially available silicone elastomer has already been published by Hanstein et al. (S. Hanstein, D. de Beer and H. Felle, Sensors and Actuators 2001, B81, 107-114). The sensor presented in said publication possesses a gasket made of a silicone mass for dispersion coatings which was manufactured in a single-step process.

In contrast to the silicone gasket and the manufacturing process, both based on the current invention, the gasket that has been published is disadvantageous. The cross-linking reaction of the silicone mixture used, already begins when the silicone contacts the aqueous phase thus increasing the viscosity of the silicone in such a way that at maximum one out of four sensor tips can be sealed successfully. The already published manufacturing method does not allow for further miniaturizing of the sensor.

Based on the present invention, the two-stage manufacturing process based on the current invention distinguishes itself from the state of the art in its significant facilitation of the absorption of the phase boundary between the aqueous and hydrophobic phase within narrow microcapillaries or, in the case of extremely narrow capillaries, in rendering this absorption possible for the very first time.

The manufacturing process based on the current invention avoids a too rapid polymerization of the liquid silicone mass. If required, the length of the silicone phase within the sensor tip may be reduced belatedly. A crucial advantage of the manufacturing process based on the current invention is its remarkably low manufacturing defect rate in comparison to the state of the art. Furthermore, since a thinner silicone gasket can be achieved more efficiently, the gasket based on the current invention is characterized by a higher measurement sensitivity. The higher measurement sensitivity causes an improved reproducibility of measurement results with lower analyte concentrations. The novel silicone gasket based on the current invention fulfills the requirements of electrically insulating the internal electric circuit of the sensor from the analyte solution resp. the analyte and allowing for a high permeability of the substance to be analyzed.

It is the problem of this invention to provide gaskets for microsensors that eliminate the known disadvantages of the current state of the art. This problem is solved based on the current invention through gaskets which possess a high permeability for the analytes to be measured, electrically insulating characteristics and can be implemented in microsensors. Preferably, these gaskets are composed of a non-cross-linking silicon with a low viscosity and a cross-linking silicon.

The gasket, based on the current invention, is applicable in microsensors, with the help of which, substances that are able to permeate the respective gasket can be analyzed on a micro scale. The invention enables the construction of very small, highly sensitive and selective sensors which neither alter nor affect the metabolism of biological samples. It is suitable for microsensors that are utilized in the field of cell biology, e.g. for measuring CO₂ and O₂ concentrations as control factors of the cellular energy metabolism and the cellular absorption of substances, or for measuring the formation of CO₂ and NH₃ in sources of infection in host cells or microbial pathogens.

Through the doping of the electrolytes behind the silicone gasket with an appropriate determined primary analyte from a biological sample into a secondary analyte. By applying the silicone gasket based on the current invention in a sensor in combination with the enzyme doping of the electrolyte and a suitable measuring electrode, it is possible to amperometrically or potentiometrically measure the secondary analyte.

As a result of the construction, the gasket is particularly appropriate for sensors with which e.g. carbon dioxide is to be measured on single stomata of plant leaves as a control value of opening and closing movements of the stomata.

It is a further problem of the invention to provide a procedure for the production of gaskets which are analyte permeable, electrically insulated, and implementable in microsensors.

Based on the current invention, this problem is solved by a two-step procedure to produce a silicone gasket. In the first step, a non-cross-linking silicone oil with a low viscosity is inserted in the end of a microsensor. The low viscosity allows for absorption through fine sensor tips, e.g. through 2 μm narrow glass micropipettes. The absorption takes place with the help of an adapter. In the second step, the non-cross-linking silicone oil is brought in contact with a cross-linking silicone in such a way that the cross-linking first occurs when the silicone is located in the correct position within the sensor tip. The low viscosity of the non-cross-linking silicone oil is required for the placeability of the silicone oil mixture within the tip of the glass micropipette. The mixing of the two silicone oils in the micro scale is achieved through the movement during the diffusion of the silicone molecules.

It is a further problem of the invention to provide a procedure for the production of microsensors utilizing the gasket based on the current invention. This procedure is solved based on the invention by, first of all, (as described above) producing a gasket which is based on the current invention in a micropipette. Directly thereafter, from behind, an enzyme-containing solution is inserted into the first glass micropipette. Subsequently, the freshly produced gasket hardens. Afterwards, a second glass micropipette is filled with a proton sensitive cocktail solution and PVC in THF. Through the evaporation of the solvent THF, a solid PVC-gel is formed. The solid PVC-gel is, first of all, coated with an undiluted proton sensitive cocktail and then with a reference buffer. Lastly, a working electrode is implemented.

The first glass micropipette with the silicone gasket based on the invention is equipped with an electrode (reference electrode) which protrudes into the enzyme solution. Subsequently, the second glass micropipette—prepared as described—is pushed into the tip of the first glass micropipette in such a way that the tip of the second, inner micropipette protrudes about 2.5 cm out of the opposite end of the first, outer micropipette. The two micropipettes are fixed together with an adhesive. The outwardly protruding end is then connected with a conventional electrode holder. Numerous procedures are known within the state of the art to produce permeable membranes, gaskets, and insulator coatings out of silicone-containing material. The procedures known to experts are however not suitable for electrically sealing a aqueous phase with a coating within a microsensor whose tip has a diameter of 2 μm or less.

The gasket based on the invention distinguishes itself through it's ability, on the one hand, to electrically insulate the analytes to be determined, and, on the other, however, shows a high permeability for this analyte so that the analyte can rapidly permeate the membrane to the actual measuring area of the gasket-equipped sensor.

In order to produce silicone gaskets based on the invention according to the procedure which is also based on the invention, a non-cross-linking silicone oil 1 is poured into a reservoir capillary 6 (see FIG. 1) and levelly mounted under a microscope objective 6. The glass micropipette that is to be sealed 4 is filled with distilled water and inserted into the capillary 6. At the other end of the glass 5, there is an adapter head 12 attached (see FIG. 3), at the end of which a 50 ml syringe 17 is located. The rubber gasket 11 is fastened at the end 5 of the glass micropipette with the help of a gasket screw 12. Subsequently, the adapter device is clamped to a metal tube 13 in a micromanipulator. The metal tube is connected through plastic hose 14 and a three-way cock 15 to a 50 ml syringe 17 with a Luerlock adapter. By closing the three-way cock 15 and pulling the plunger of the syringe 17, low pressure is produced and, under microscope supervision, the non-cross-linking silicone 1 is aspirated into the glass micropipette 4. As the interface tension between the silicone phase and the aqueous phase has to be overcome within the tip 4, this is done jerkily. Hereby, the required acute phase interface, without any bulges is only achieved, if the aqueous phase is protein free. Excessive silicone is pressed out the tip in two steps: First, the plunger of the syringe is pressed down so far that the plug is five times longer than it should be in the final gasket. Afterwards, the glass micropipette 4, adapter and syringe are removed from the reservoir capillary. The truncation of the plug to the final length of the gasket is achieved by pushing the syringe plunger, whereupon excess 1 runs out. Alternatively to the aspiration procedure described here, the interfacial tension between water and silicone can be reduced in such a manner that an excess free aspirating of the silicone into the syringe is possible (that it is possible to aspirate the silicone excess free into the syringe) by adding surface active substances (e.g. non-ionic tensides) to the water. The cross-linking silicone oil 8 is placed on the holder 7 and brought into contact with the glass micropipette 4 which is filled with the non-cross-linking silicone (see. FIG. 2). The holder with 8 is placed close to the tip 4, and 8 interacts twice for preferably 45 sec with the non-cross-linking silicone oil 3. The interruption of the interaction prevents the adhesion of the cross-linking silicone oil to the exterior of the glass micropipette and the extraction of the non-cross-linking silicone oil during the removal of the drop of cross-linking silicone oil. The glass micropipette must not protrude further than 10 μm into the cross-linking silicone oil, otherwise the sensor diameter is increased due to the adhesion of the cross-linking silicone oil to it's exterior. After removing the glass micropipette 4 from the non-cross-linking silicone 8, the filling capillary 9 with the enzyme-containing electrolyte 18 is inserted from behind into the glass micropipette 4. The gasket subsequently cures for approx. 2-6 hours at room temperature. Alternatively, the curing can also occur between 40-80° C. in the presence of humidity, which accelerates the curing process by several hours. Curing times of 4 hours at room temperature are particularly preferred, and respectively for 1 hour in humid warmth at approx. 60° C.

The enzyme 18 in the filling capillary 9 is utilized to quantitatively and stoichiometricly convert the primary analyte into a secondary analyte, which is subsequently measured. A particularly appropriate enzyme is, for instance, carboanhydrase (CO₂).

The enzyme can be stabilized with appropriate antioxidants. Appropriate antioxidants are, for instance, ascorbinic acid, glutathione, rosmarinic acid, benzoic acid, and catechines. Either potentiometric (pH, NH₄⁺) or amperometric microsensors (ref. S. Hanstein, D. de Beer and H. Felle, Sensors and Actuators 2001, B81, 107-114) are utilized as transducers for measuring the concentration of primary or secondary analyte beyond the silicone gasket. They are inserted from the end that is not doped with the gasket into the glass micropipette 4.

The microsensor based on the current invention is characterized by realizing the advantages of the gasket, also based on the current invention, within a design which can be utilized for measurements of the smallest quantities of analytes and/or for measurements within the smallest of spaces.

The production of the microsensor based on the current invention is a further technical development of a microsensor described within the literature (ref. S. Hanstein, D. de Beer and H. Felle, Sensors and Actuators 2001, B81, 107-114).

In order to produce the microsensors based on the current invention, first a gasket, which also forms part of the current invention, is produced as described above.

Afterwards, a proton sensitive cocktail is dissolved in PVC/THF and poured into a second glass micropipette (23).

After the evaporation of the solvent, a solid PVC-gel is formed. The solid PVC-gel is, first of all, coated with an undiluted proton sensitive cocktail and then with an appropriate reference buffer. The second glass micropipette 23, the proton sensitive cocktail 24 and the reference buffer, together with a working electrode, which is to be installed, form the pH-sensitive microsensor 20. Preferably, a conventional electrode holder is utilized, in which one electrode is integrated and allows the pH-sensitive micro electrode to connect with a further electrode. The electrode integrated into the electrode holder contains a metal and the salt thereof. Preferably, a precious metal and a precious metal salt are utilized.

A reference electrode 21 is inserted into the first glass micropipette 4. Afterwards, the pH-sensitive microelectrode 20 is inserted into the first glass micropipette 4 and placed as close as possible to the silicone gasket 22 at a distance of approx. 20 μm from the tip aperture. The two glass micropipettes are immediately fixed to one another with an adhesive, whereby approx. 2.5 cm of the end opposite the gasket—the end where the pH-sensitive microelectrode 20 is located—remains free. This end 25 is inserted into a conventional electrode holder.

### Practical Embodiments

1. Procedure to Produce the Gasket

The Dow Corning product 200 (R) fluid with a viscosity of 0.1 stokes (25° C) and an activity of 100% was selected as the non-cross-linking silicone oil. The employed reservoir capillary had an inner diameter of 2 mm. Before starting the production, the glass micropipette to be sealed had been filled with 1 μm of distilled water. As the cross-linking silicone oil, the Dow Corning product (R) 1340 RTV Coating was utilized.

Alternatively, mixtures of a silanol with a viscosity of 50-120 cSt, e.g. Dow Corning Product DC 2-1273, or a silanol with a viscosity of 2,000 cSt, e.g. Dow Corning Product DC 3-0133, with 5-10 weight per cent of methyl-trimethoxy-siloxane respectively, can be utilized.

2. Procedure for the Utilization of the Gasket within a Microsensor and Production of the Microsensor

The gasket and the microsensor are produced as described above. The glass micropipette 4 and the filling capillary with enzyme electrolyte 9 are made of glass—preferably borosilicate glass (e.g. by the company Hilgenberg GmbH, Malsdorf, Germany)—and are silanized prior to the production of the gasket with a solution of 0.2% tributyl-chlorosilane in chloroform, according to the procedure known to the expert.

In order to utilize the gasket within a sensor to measure CO₂, a carboanhydrase solution is poured into the filling capillary 9. First, a 1% chloramphenicol stock solution in ethanol as well as a buffer solution consisting of 1 mM NaHCO₃ and 100 mM NaCl (pH 8.3) are hereunto produced. The enzyme solution is subsequently prepared from 0.4 ml of the aforementioned NaHCO₃ buffer solution, 3 mg lyophilized carboanhydrase and 2 μl of the chloramphenicol stock solution and immediately utilized for filling the filling capillary. The carbianhydrase solution has been stabilized prior to the filling with an antioxidant with preferably 5 mM ascorbic acid.

In order to utilize the gasket within a CO₂ mircosensor, another glass micropipette of borosilicate glass (outer diameter 1 mm, inner diameter 0.6 mm) is silanized as described above. A proton-sensitive hydrophobe cocktail known to the expert (preferably Fluka product #95297, hydrogen ionophore II cocktail A, Selectophore®) is dissolved in a mixture of 40 mg PVC/ml THF with a 30:70 (V/V) ratio. This (hydrophobe) solution is filled into the second glass micropipette from behind with the help of a filling capillary. Through the utilization of a silanized glass micropipette, the (hydrophobe) solution concentrates in the tip of the glass micropipette without leaking out. The THF is removed within the vacuum, whereby a hard PVC-gel is formed. The solid PVC-gel is, first of all, coated with an undiluted proton sensitive cocktail and afterwards with a reference buffer. Reference buffer: 100 mM 2-[N-]morpholino-]ethane sulfonic acid is adjusted with a solution of 100 mM tris(hydroxymethyl)-aminomethane to pH 8.3, then 100 mM KCl are added.

A silver-silver chloride electrode is utilized as a reference electrode (installed into the first glass micropipette). Production: Approx. 1 mm of the teflon coating of a teflon coated silver wire is removed and the uninsulated silver tip is chloridized at 300 μA in a 3M KCl-solution.

The assembly is realized as described above. Both glass micropipettes are immediately fixed to one another with adhesive—preferably with a cyan acrylate adhesive—according to custom and usage, (e.g. Tesa® superglue, Beiersdorf AG, Hamburg, Germany). The free end, at the opposite side of the silicone gasket, of the second glass micropipette is subsequently inserted into a conventional electrode holder. This electrode holder contains a Ag-AgCl die framed in plastic, which serves as the reference electrode.

The portion of the outer glass micropipette, in which the chloridized tip of the silver electrode is located, is furnished with a 5 mm acrylic ring, as the electric potential on the Ag/AgCl-electrode is light sensitive.

### FIGURE INFORMATION AND LEGEND

5 figures are listed in the following.
1. non-cross-linking silicone
2. microscope objective
3. distilled water
4. first glass micropipette (outer pipette)
5. site to attach the adapter
6. reservoir capillary
7. holder
8. cross-linking silicone
9. filling capillary with enzyme electrolyte
10. gasket screw
11. rubber gasket
12. adapter head
13. metal tube to clamp the adapter into the micromanipulator
14. flexible hose (only start and end are plotted)
15. three-way cock
16. Luerlock adapter
17. syringe (50 ml)
18. enzyme electrolyte
19. adhesive
20. pH-sensitive microelectrode
21. reference electrode
22. silicone gasket
23. second glass micropipette (inner pipette)
24. proton-sensitive cocktail
25. site to attach the electrode holder

FIG. 1:

Schematic illustration of the insertion of the non-cross-linking silicone oil (1) into the glass micropipette (4), under microscopic supervision (2). The tip of the glass micropipette (4) is filled with distilled water (3). The adapter is fixed at the rear end (5) of the capillary. The glass micropipette, filled with water, is inserted into the capillary (6) with the silicone oil (1). Pulling the plunger of the adapter syringe (ref. FIG. 3), negative pressure is generated and the silicone oil (1) is aspirated into the Glass micropipette (4).

FIG. 2:

Schematic illustration of the insertion/introduction of the cross-linking silicone oil (8). The cross-linking silicone oil (8) is applied to the holder (7) and brought in contact with the glass micropipette (4). After removing the glass micropipette (4) from the non-cross-linking silicone oil (8), the filling capillary with enzyme-containing electrolyte (9) is inserted from behind into the glass micropipette (4).

FIG. 3:

Illustration in cross section: Adapter to aspirate non-cross-linking silicone oil (1) into the tip of a glass micropipette (4). The adapter is composed of a gasket screw (10), rubber gasket (11), adapter head (12), a metal tube (13) to clamp the adapter into the micromanipulator and a flexible hose (14).

FIG. 4:

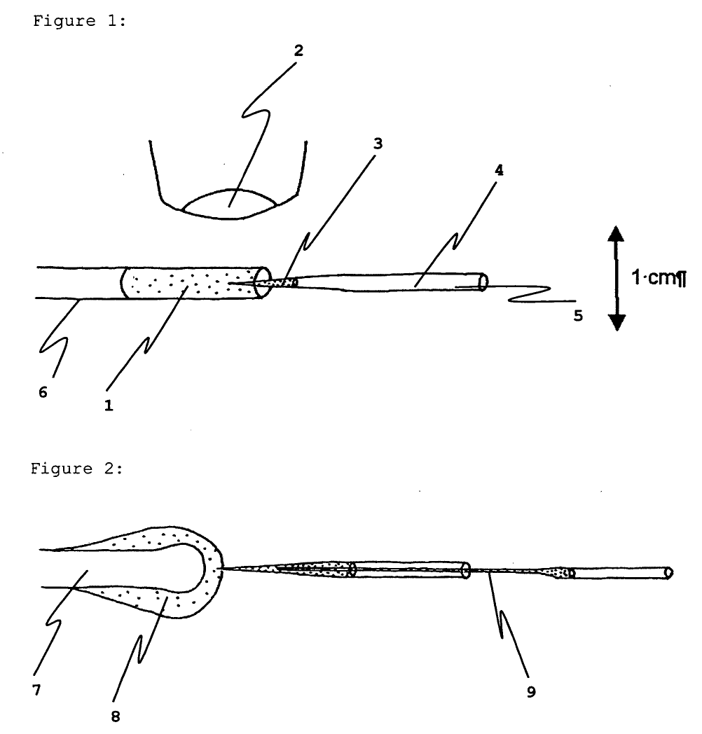

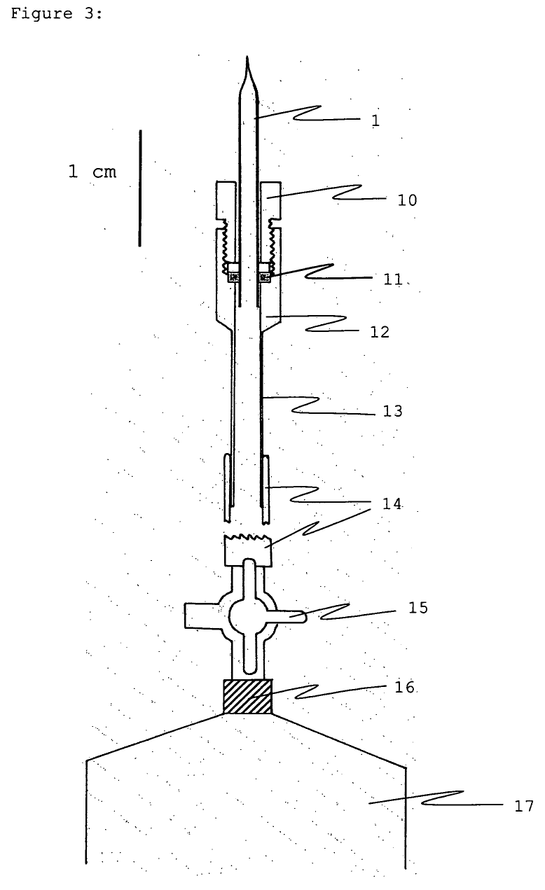

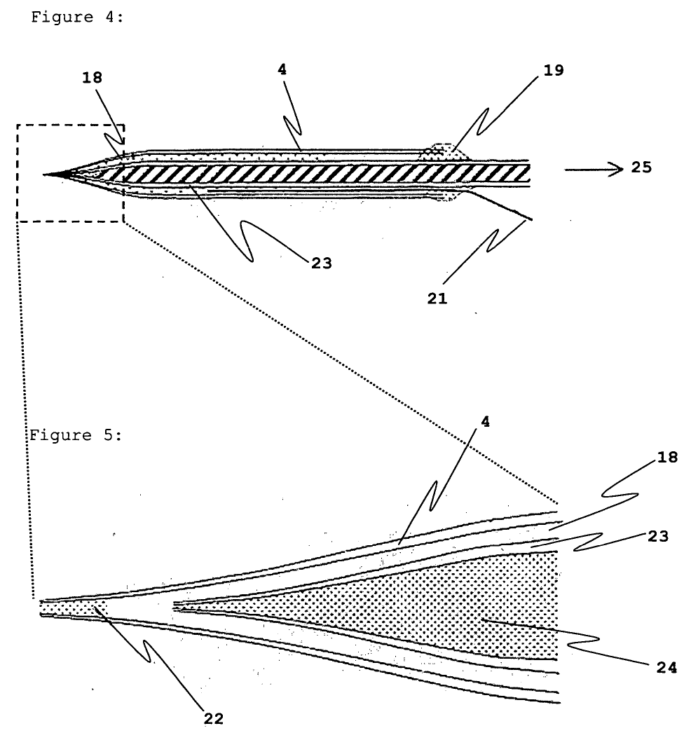

Schematic illustration of the completed microsensor: The microsensor is composed of two concentrical glass micropipettes (4 and 23), which are inserted and fixed to one another with an adhesive (19). The inner glass micropipette (23) contains a proton-sensitive cocktail (24) coated with a reference buffer. The inner glass micropipette, together with the proton-sensitive cocktail coated with a reference buffer and working electrode form the pH-sensitive microelectrode (20). Preferably, an electrode which is integrated into a conventional electrode holder is utilized as a working electrode. The pH-sensitive microelectrode (20) is placed in the tip of the outer glass micropipette (4). The tip of the pH-sensitive microelectrode (20) is hereby located approx. 20 μm beyond the tip of the outer glass micropipette (4), which is closed with a silicone gasket (22) produced according to the procedure based on the current invention. The space between the outer glass micropipette (4) and the pH-sensitive microelectrode (20) is filled with an enzyme solution (18). A reference electrode (21) connects the enzyme solution with the grounding. The rear end (25) of the pH-sensitive microelectrode is to be connected with a conventional electrode holder.

FIG. 5:

Schematic illustration of the tip of the completed microsensor: the silicone gasket (22) produced according the procedure based on the current invention is located in the tip of the outer, first glass micropipette (4). The space beyond this silicone gasket (22) is filled with enzyme electrolyte (18). The tip of the second glass micropipette (23) is inserted the tip of the first glass micropipette (4). The tip of the second glass micropipette (23) contains a proton selective cocktail (24).

1. Gasket for sensors to measure gas concentrations, characterized by a mixture of silicone polymers, which are permeable for gas molecules.

2. Procedure to produce a gasket within a glass micropipette, preferably within the tip of a glass micropipette, particularly of a silicone gasket for microsensors to measure gas concentrations, characterized by the following steps:
1. Aspiration of a non-cross-linking silicone oil into a glass micropipette filled with a liquid, preferably water.
2. The pressing out of the excess non-cross-linking silicone oil.
3. Immersion of the tip of the glass micropipette into a drop of cross-linking silicone oil.
4. Leave the tip of the glass micropipette in the cross-linking silicone oil for at least 5 seconds.
5. Removal of the glass micropipette from the cross-linking silicone oil.
6. Repetition of steps 4 to 6 until the desired degree of cross-linking is achieved.
7. Curing of the silicone gasket.

3. Procedure to produce a gasket for microsensors, preferably a silicone gasket for microsensors to measure gas concentrations, according to claim 2, characterized by the fact that the glass micropipette is made of either borosilicate, aluminum silicate or quartz glass.

4. Procedure to produce a gasket for microsensors, preferably a silicone gasket for microsensors to measure gas concentrations, according to claim 2, characterized by an inner diameter of less than or equal to 12 μm, preferably between 0.5 μm and 2 μm, particularly preferred between 1.75 and 2 μm.

5. Procedure to produce a gasket for microsensors, preferably a silicone gasket for microsensors to measure gas concentrations, according to claim 2, characterized by a gasket length of less or equal to 50 μm, preferably between 5 μm and 20 μm, particularly preferred between 8 μm and 12 μm.

6. Procedure to produce a gasket for microsensors, preferably a silicone gasket for microsensors to measure gas concentrations, according to claim 2, characterized by the utilization of silicone, which possesses electrical insulating characteristics.

7. Procedure to produce a gasket for microsensors, preferably a silicone gasket for microsensors to measure gas concentrations, according to claim 2, characterized by an inner diameter of the tip of the glass micropipette of less or equal to 4 μm.

8. Procedure to produce a gasket for microsensors, preferably a silicone gasket for microsensors to measure gas concentrations, according to claim 7, characterized by filling the glass micropipette with water prior to the aspiration of the non-cross-linking silicone oil, whereby surface active substances, preferably non-ionic tensides, had been added to the water in such a way that, in case surface active substances had been added, the pressing out of excess non-cross-linking silicone oil according to procedure steps 2 and 3 of claim 2 can be omitted.

9. Procedure to produce a gasket for microsensors, preferably a silicone gasket for microsensors to measure gas concentrations, according to claim 2, characterized by silanizing of the glass micropipette prior to the production of the gasket.

10. Procedure to produce a gasket for microsensors, preferably a silicone gasket for microsensors to measure gas concentrations, according to claim 2, characterized by the utilization of a non-cross-linking silicone oil with terminal trimethyl-siloxy groups, preferably a non-cross-linking polydimethylsiloxane with terminal trimethyl-siloxy groups, particularly preferred is a non-cross-linking polydimethylsiloxane with terminal trimethyl-siloxy groups with a viscosity between 0.02 and 0.5 stokes, even more particularly preferred is a non-cross-linking polydimethylsiloxane with terminal trimethyl-siloxy groups with a viscosity between 0.05 and 0.1 stokes.

11. Procedure to produce a gasket for microsensors, preferably a silicone gasket for microsensors to measure gas concentrations, according to claim 2, characterized by the utilization of a cross-linking silicone made from a mixture of, on one hand, dimethylsiloxane with terminal hydroxyl groups and trimethyl-siloxy and, on the other, a cross-linker, preferably of a cross-linking RTV silicone oil mixture, of, on one hand, dimethylsiloxane with terminal hydroxyl groups and trimethyl-siloxy and, on the other, a cross-linker, particularly preferred is a cross-linking RTV silicone oil mixture of, on one hand, dimethylsiloxane with terminal hydroxyl groups and trimethyl-siloxy as well as 5-10% methyltrimethoxysiloxane as cross linker, even more particularly preferred is a cross-linking RTV silicone oil mixture, of, on one hand, dimethylsiloxane with terminal hydroxyl groups and trimethyl-siloxy as well as 5-10% methyltrimethoxysiloxane as cross linker, whereby the cross-linking RTV silicone oil mixture of dimethylsiloxane with terminal hydroxyl groups and trimethyl-siloxy as well as 5-10% methyltrimethoxysiloxane as cross linker possess a viscosity of less than or equal to 28,000 cSt.

12. Procedure to produce a gasket for microsensors, preferably a silicone gasket for microsensors to measure gas concentrations, according to claim 2, characterized by curing the silicone gasket for 2 to 6 hours at room temperature, preferably for 3 to 5 hours at room temperature, particularly preferred for 4 hours at room temperature.

13. Procedure to produce a gasket for microsensors, preferably of a silicone gasket for microsensors to measure gas concentrations, according to claim 2, characterized by curing the silicone gasket in humid warmth of 40-80° C., preferably for 0.5-4 hours at 50-70° C., particularly preferred for 45-75 minutes at 55-65° C.

14. Procedure to produce a microsensor to measure gas concentrations, whereby a gasket characterized by a mixture of silicone polymers which are permeable for gas molecules is employed, characterized by the following steps:
1. Production of the gasket according to claim 2, whereby the glass micropipette is, after removal from the cross-linking silicone oil, in the case of achieving the desired degree of cross-linking, first of all, doped with an enzyme solution and the gasket is afterwards cured according to.
2. Filling of a second glass micropipette with a solution of a proton sensitive cocktail and a liquid polymer, whereby the filling is realized from the opposite side to the tip of the glass micropipette.
3. Hardening of the mixture of proton sensitive cocktail and polymer, in such a way that the tip of the pipette seals/closes itself
4. Coating of the hardened mixture with proton sensitive cocktail and a reference buffer
5. Insertion of a working electrode into the second glass micropipette
6. Insertion of a reference electrode into the first glass micropipette
7. Insertion of the tip of the second glass micropipette into the first glass micropipette, maintaining a distance between the tip of the second glass micropipette and the silicone gasket
8. Fixing both glass micropipettes to one another with an adhesive.

15. Procedure to produce a microsensor to measure gas concentrations according to claim 14, characterized by abstaining from the installation of a working electrode and connecting instead the rear end of the second glass micropipette, after fixing together both glass micropipettes, with a conventional electrode holder, whereby the electrode holder contains an electrode made of metal and a salt thereof.

16. Procedure to produce a microsensor to measure gas concentrations according to claim 15, whereby a gasket according to claim 1 is utilized, characterized by an electrode made from a silver-silver chloride die framed in plastic.

17. Procedure to produce a microsensor to measure gas concentrations according to claim 14, characterized by the utilization of the enzyme carboanhydrase.

18. Procedure to produce a microsensor to measure gas concentrations according to claim 17, characterized by adding an antioxidant to the enzyme, preferably an antioxidant from the group ascorbinic acid, glutathione, catechines, benzoic acid, and rosmarinic acid. Ascorbinic acid is particularly preferred.

19. Procedure to produce a microsensor to measure gas concentrations according to claim 14, characterized by the utilization of non-toxic electrodes, preferably of silver-silver chloride electrodes.

20. Utilization of a gasket within a microsensor according to claim 14, characterized by the employment of the microsensor to measure gases out of the group carbon dioxide, ammoniac and oxygen, preferably to measure carbon dioxide.

21. In a method of employing a microsensor for biological system analysis the improvement comprising the use of a gasket within a microsensor according to claim 14.

22. Utilization of a gasket within a microsensor according to claim 21, characterized by the employment of the microsensor for the analysis of gases in phytophysiological systems, preferably for the measurement of the cell respiration, particularly preferred for the measurement of carbon dioxide and/or NH₃ in plant leaves, even more particularly preferred for high resolution measurements of carbon dioxide and/or NH₃ in the single stomata of plant leaves.

23. Procedure to produce a microsensor to measure gas concentrations according to claim 15, characterized by the utilization of the enzyme carboanhydrase.

24. Procedure to produce a microsensor to measure gas concentrations according to claim 23, characterized by adding an antioxidant to the enzyme, preferably an antioxidant from the group ascorbinic acid, glutathione, catechines, benzoic acid, and rosmarinic acid. Ascorbinic acid is particularly preferred.

25. Procedure to produce a microsensor to measure gas concentrations according to claim 15, characterized by the utilization of non-toxic electrodes, preferably of silver-silver chloride electrodes.

26. Utilization of a gasket within a microsensor according to claim 15, characterized by the employment of the microsensor to measure gases out of the group carbon dioxide, ammoniac and oxygen, preferably to measure carbon dioxide.

27. In a method of employing a microsensor for biological system analysis, the improvement comprising the use of a gasket within a microsensor according to claim 15.

28. Utilization of a gasket within a microsensor according to claim 27, characterized by the employment of the microsensor for the analysis of gases in phytophysiological systems, preferably for the measurement of the cell respiration, particularly preferred for the measurement of carbon dioxide and/or NH₃ in plant leaves, even more particularly preferred for high resolution measurements of carbon dioxide and/or NH₃ in the single stomata of plant leaves.
